(19) United States
(12) Patent Application Publication
(10) Pub. No.: US 2019/0370793 A1
(43) Pub. Date: Dec. 5, 2019

(54) HYBRID CONSENSUS FOR BLOCKCHAIN USING PROOF OF WORK AND PROOF OF STAKE

(71) Applicant: Decentralized Finance Labs, Inc., Milpitas, CA (US)

(72) Inventors: Xiaohan Zhu, San Jose, CA (US); Yang Yu, San Ramon, CA (US)

(21) Appl. No.: 16/430,398

(22) Filed: Jun. 3, 2019

Related U.S. Application Data
(60) Provisional application No. 62/680,551, filed on Jun. 4, 2018.
(60) Provisional application No. 62/694,569, filed on Jul. 6, 2018.

(51) Int. Cl. G06Q 20/36; G06Q 20/40; H04L 9/06

(52) U.S. Cl. CPC G06Q 20/3678; G06Q 20/401; H04L 2209/56; G06Q 2220/00; H04L 9/0637

(57) ABSTRACT

A proof of stake system is used to create new blocks in which a proposer of a block within a validation committee selected from a candidate pool of stakeholders is chosen to write a block to the blockchain. The validation committee is selected through a proof of work method using miners to solve cryptographic puzzles. This provides a sufficient degree of randomness with regard to the selection of validation committee and the ultimate block proposer. It also adds a sufficient aspect of absolute time in that a finite amount of time is required by the miners to solve the puzzles. The identity of the proposers is random and timestamps and other indicia of time cannot be faked as there is a real-world aspect to the timestamps.

### CROSS-REFERENCE TO RELATED APPLICATIONS

This application claims the benefit of U.S. Provisional Application No. 62/680,551, filed Jun. 4, 2018, and U.S. Provisional Application No. 62/694,569, filed Jul. 6, 2018.

### TECHNICAL FIELD

Embodiments are directed generally to blockchain technology, and more specifically to hybrid consensus methods using both proof of work and proof of stake methods.

### BACKGROUND

Blockchain technology has been developed to provide decentralized, secure, and immutable storage of data for transactions among users. A blockchain is a public, distributed ledger of information collected through a peer-to-peer network comprising many nodes. A blockchain itself is a growing list of blocks (records) that are linked by each block containing a cryptographic hash of the previous block along with a timestamp and transaction data. A blockchain can be used to store virtually any type of digital element (e.g., records, transactions, contracts, computer applications, etc.) in a verifiable and permanent manner. In a typical blockchain implementation, transactions are bundled together into a block, the transactions within each block are verified through a mining process, and the verified transactions are stored on the blockchain.

Every record that is written to a blockchain is secured by a unique cryptographic key, and data written to a blockchain cannot be changed. Because a blockchain is decentralized, there is no central authority that validates the data or transactions recorded in the ledger. Instead, blockchain relies on certain consensus mechanisms to make decisions regarding the storage of transaction data. Consensus is required since all nodes in a distributed network can each access the history of transactions or confirm new transactions. At present, two main consensus mechanisms exist: Proof of Work (PoW) and Proof of Stake (PoS).

In a typical blockchain system, miners solve cryptographic puzzles to “mine” a block in order to add to the blockchain. The mining mechanism is used to verify the legitimacy of a transaction (such as to avoid the double-spending problem), and to create a basis for rewarding miners to add blocks by verifying transactions. The puzzles are generally difficult and require significant computing power and energy, and are designed primarily to prevent Sybil attacks to the system. A Sybil attack is one that undermines network trust using forged identities, and is often used by malicious actors to control a distributed network by creating multiple fake identities. In a PoW system, miners compete to solve each puzzle, and when a miner solves the puzzle, it broadcasts its block to the other network nodes for verification. Verifying whether the block belongs to the chain or not is an extremely simple process, unlike the puzzle solving process. FIG. 1A illustrates a simple PoW process as is presently known. As shown in FIG. 1B, a first miner (Miner 1) among many miners solves a puzzle (Puzzle 1) and adds his winning block directly to the blockchain ledger 112, and receives a reward. The next puzzle (Puzzle 2) is solved by a second miner (Miner 2) who adds his or her block to the ledger, and so on. In this manner, the blockchain grows on each winning block.

A PoS system makes the entire mining process virtual and replaces miners with validators. The validators commit some of their cryptocurrency coins as a stake. After that, they start validating the blocks such that when they discover a candidate block that can be added to the chain, they will validate it by placing a bet on it. If the block gets appended, then the validators will get a reward proportionate to their bets. Whereas PoW methods rely almost entirely on competition among competitors, PoS is more selection-oriented in that higher stake validators have a higher chance of being selected, even though there may be some use of random functions to pick block producers or committee members among all the stakeholders. As shown in FIG. 1B, a first validator (Validator 1) puts up their stake (Stake 1) and is selected to add their block to the blockchain ledger 14. This selection is performed deterministically on the basis of the size of the stake. The block to be added goes to the next validator (Validator 2) that puts up the highest stake (Stake 2), and so on.

In a typical blockchain system, and as shown in FIGS. 1A and 1B, the ledgers (e.g., 112 and 114) are maintained by the miners (such as in PoW) or validators (such as in PoS). In either consensus system, the miners/validators maintain the security and keep the ledger of the system. In return, the system rewards them with newly minted coins and/or transaction fees. In such systems the rights for generating blocks (e.g., minting coins) and bookkeeping (maintaining the ledger) are the same. The PoW and PoS based systems provide different benefits, however they also pose different problems based on the fact that they both involve common block creation and ledger management functions.

The PoW method allows any of the participants to become a token holder as long as they participate the mining process. However, when a PoW based chain is still at its early days of adoption, it is relatively easy to attack the system in short term with a lot of computing power. The cost for such short-term attack maybe much lower than the gains it brings. In addition, PoW based systems tend to have limited throughput due to the amount of time needed for PoW computations, which must be significant to make the system secure.

A PoS system alleviates such problems by giving bookkeeping priorities to major stakeholders of the system. However, with PoS, as newly minted tokens go to these stakeholders as well, the token holders become more and more concentrated over time, thus leading to a skewed distribution of wealth. PoS systems also suffer from long range attack scenarios in which a malicious actor may be able to go back to the creation of the first block in a chain and create a new chain. This is possible because PoS do not adequately maintain a strict notion of absolute time. Although the blocks contain timestamps, these can be faked in a PoS system, leading to the possibility of such long range attacks

What is needed, therefore, is a hybrid consensus system, where the token mining and bookkeeping functions are separated from one another in order to minimize the disadvantages associated with each of the PoW and PoS consensus methods. What is further needed, is a blockchain method that adds the aspect of time and randomness to PoS consensus methods to provide a secure way to add blocks to a blockchain.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1A illustrates a simple proof of work (PoW) process as is presently known.

FIG. 1B illustrates a simple proof of stake (PoS) process as is presently known.

FIG. 2 illustrates an example blockchain network that implements a hybrid proof of work and proof of stake consensus process for cryptocurrencies, under some embodiments.

FIG. 3 illustrates a relationship between PoW and PoS processes in a hybrid consensus system for blockchains, under some embodiments.

FIG. 4 illustrates the use of PoW processes in conjunction with PoS block creation and validation in a hybrid consensus method for a blockchain system, under some embodiments.

FIG. 5 is a flowchart illustrating an overall method for hybrid PoW/PoS consensus in a blockchain system, under some embodiments.

FIG. 6 illustrates the functional components in a processor-based system for providing hybrid consensus in a blockchain system, under some embodiments.

FIG. 7 illustrates a method of the consensus protocol as a variant of a Byzantine agreement, under some embodiments.

FIG. 8 graphically illustrates an interaction among the PoS and PoW chains and validation committee formation in an hybrid consensus system, under some embodiments.

FIG. 9 is a block diagram of a computer system used to execute one or more software components of a hybrid consensus process, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the described embodiments.

Embodiments are directed to a process and system of implementing a hybrid consensus system for a blockchain network where the token mining and bookkeeping functions are separated from one another. A PoS consensus system is used to create new blocks in which a proposer of a block is part of a validation committee selected from a bigger candidate pool of stakeholders. The validation committee is randomly selected from the candidate pool by the results of a PoW method using miners to solve cryptographic puzzles. This provides a sufficient degree of randomness with regard to the selection of validation committee and the ultimate block proposer. It also adds a sufficient aspect of absolute time in that a finite amount of time is required by the miners to solve the puzzles. Therefore, the identity of the proposers is truly random and timestamps and other indicia of time cannot be faked as there is a real-world aspect to the timestamps in the PoS blockchain.

In a cryptocurrency or similar application environment, PoW-based consensus is used to randomly define groups containing potential PoS proposers of new tokens to maintain the diversification of the token holders and create economic consensus on the value of the tokens. The PoS-based validators maintain the ledger and accounting for the system. This separates the currency creation from the ledger management functions for the PoW miners, and alleviates the time and randomness problems associated with present PoS systems, as described above.

Although embodiments are described with respect to blockchain technology, embodiments are not so limited. Embodiments can apply to a distributed public ledger implemented on any type of tree, multitree or graph structure, such as directed acyclic graphs (DAG) which is a finite directed graph with no directed cycles. Such a graph or tree would use proof of work to create randomness and a notion or aspect of time to complement a proof of stake consensus system.

As is known, a blockchain is a growing list of records (blocks) that are cryptographically linked to one another. Each block may be a bundle of transactions and contains a timestamp indicating when it was written to the ledger, the transaction data, and a cryptographic hash of the previous block. The cryptographic hash in each block links the blocks together by referencing an immediately preceding block. A blockchain is resistant to modification of the data and represents an open, distributed ledger that can record transactions between two parties efficiently and in a verifiable and permanent way. A blockchain is typically managed by a peer-to-peer network adhering to a protocol for internode communication and validating new blocks. Once recorded, the data in any given block cannot be altered retroactively without alteration of all subsequent blocks, which requires consensus of the network majority. Blockchain technology can be integrated into multiple applications, such as cryptocurrencies and smart contracts, where a smart contract is a protocol intended to digitally facilitate, verify, or enforce the negotiation or performance of a contract.

To record a simple transaction in a blockchain, each party and asset involved with the transaction needs an account that is identified by a digital token. For example, when one person wants to transfer an asset to another person, the current owner and next owner both create accounts, and the current owner also creates an account that is uniquely identified by an asset identification number. The account for the asset identifies the current owner. The method of processing a transaction in a blockchain network starts when an asset owner creates a transaction against the account for the asset, provides the public keys (i.e., identity tokens) of the owner and the recipient, and signs the transaction with his or her private key. The transaction request is broadcast to the blockchain network for validations. If the nodes of the blockchain network do not validate the transaction as determined, the transaction is stopped and the transfer of ownership is not recorded. If the blockchain network validates (verifies) the transaction, it is combined with other transactions occurring at the same time to form data for a new block and the new block is added to the blockchain. The recorded transaction in the blockchain is evidence that the next owner identified in the transaction request is now the current owner.

As stated above, the validation step requires some form of consensus among the blockchain nodes, such as through proof of work (PoW) or proof of stake (PoS). In present PoW systems, the miner nodes generate the new blocks as well as validate the transactions in the blocks. In present PoS systems, the validators are allowed to generate new blocks based on the amount of their stake. At present, the PoS and PoW validation mechanisms are used separately from one another in different blockchain environments. For example, the present Bitcoin environment uses PoW, while the Ethereum platform is moving to PoS from PoW. Embodiments of a blockchain system described herein include a hybrid consensus method and system that combines both the PoW and PoS mechanisms to overcome the problems associated with integrated block creation and ledger management within either the miners or validators alone.

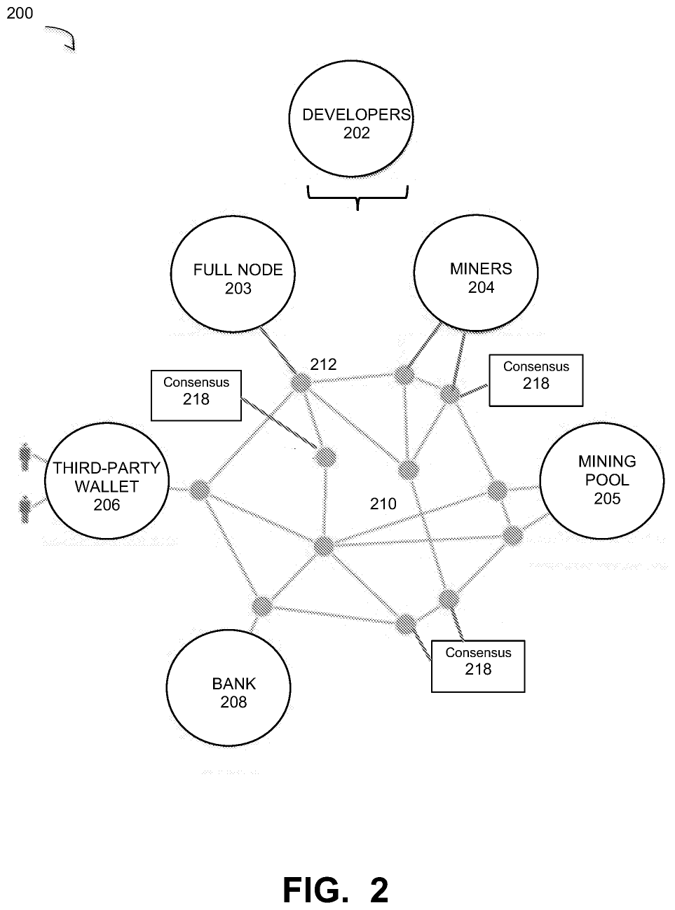

The original, and still major application of blockchain technology, is to support the implementation of cryptocurrencies through the use of blockchain tokens. FIG. 2 illustrates an example blockchain network that implements a hybrid consensus process for cryptographic currency exchanges, under some embodiments. Although FIG. 2 illustrates a cryptocurrency system, embodiments are not so limited, and any distributed network implementing a blockchain may be used. As shown in FIG. 2, system 200 is built on a distributed or peer-to-peer network 210 that is comprised of a number of nodes 212. Network 210 typically utilizes the Internet to support online interactions that occur among various entities such as developers 102, nodes 212, miners 204, and third party service providers 206. A bank 208 may also be part of the system to provide the basis for an exchange between the cryptocurrency to a fiat currency.

The blockchain network data structure includes a peer-to-peer storage protocol, which may be a protocol for storing data in a distributed fashion among nodes 212 in the network 210. The security of the blockchain is thus enhanced by storing the blockchain data on the distributed network. As shown in FIG. 2, a large number of users attempting transactions can have access to the blockchain network and miner nodes 204 can be continuously attempting to add blocks to the end of the blockchain by known mining processes, such as finding a nonce that produces a valid hash for a given block of data as in an inverse hashing process. In this process the miner determines the nonce so that the cryptographic hash algorithm of block data results in less than a given threshold. Miners 204 may work alone, or in some networks, they may be part of a mining pool 205 where miners form a group and split the proceeds among themselves to produce a (relatively) steady stream of income.

For system 200, each device or network element represents a node 212 in the network and is coupled to at least one or more other nodes for transmission of messages (data packets) in accordance with defined routing protocols. The nodes are typically embodied as computers, laptop/notebook computers, tablets, cell phones and other wired or wireless processing devices that may be coupled to each other directly or indirectly through routers and/or gateways, which may ultimately be connected to the Internet.

Network 200 may include any number of sub-networks that may be wired or wireless LAN or mesh networks containing different devices or network elements. Nodes can be added to the network, or organized into sub-networks as provided by certain known networking protocols. FIG. 2 illustrates one example of a network topology, and embodiments are not so limited. A network of any practical scale, architecture, and configuration can be used with embodiments of the processes and components described herein.

The developers 202 may develop applications to run on network 110. Such applications may be referred to as decentralized applications (dApps). A dApp is a computer application that runs on a distributed computing system, as opposed to backend code running on centralized servers for regular applications. DApps have been mostly popularized by the Ethereum blockchain, where dApps are often referred to as smart contracts. Popular dApps may be developed for use of network 210 to support cryptocurrencies.

The embodiment of FIG. 2 also includes one or more full nodes 203. A full node may be an observer node only, such as in a PoS network with non-stakeholders. A full node may also be a node that downloads every block and checks the transactions against the consensus rules. Typical consensus rules for a cryptocurrency may include: only a certain number of coins can be created per block, transactions must have the correct signatures and be in the correct data format, and within a single blockchain, transaction output (e.g., coins) cannot be double-spent. If a transaction violates any of these consensus rules, it is absolutely rejected, even if all the other nodes validate it. In general, nodes that have different consensus rules are actually using two different networks or currencies, and changing any of the rules requires hard fork (create new currency). Consensus rules are significantly different from policy rules that dictate how a node performs tasks, and which can be different among nodes and changed at will.

As shown in FIG. 2, a consensus function 218 is performed by only certain nodes of network 210, instead of being performed by all nodes or all miners as in a present PoW network. As discussed in further detail below, the nodes that perform the consensus function 218 are selected using a PoW method performed by miners 204 in order to introduce a sufficient amount of randomness to the selection of PoS block proposers that will add blocks to the ledger. PoW miners perform their normal block generation function to determine validator committees that include consensus nodes that generate and validate blocks to be added to the blockchain.

For system 200, the number of consensus nodes (i.e., nodes executing function 218) may be a defined proportion of the entire network, such as ten percent or any other relative or absolute number of nodes depending on network configuration and application requirements. These nodes are selected from an overall candidate pool comprising all or any subset of nodes in the systems, and the selected consensus nodes then form a consensus committee, or similar such grouping.

### Stable Coin Currency

In the virtual world of digital currency, the current blockchain economy lacks a cryptocurrency that functions as a true currency, that is, a currency that performs the three main functions of (1) being a unit of account, (2) being a medium of exchange, and (3) being a store of value. The current standard of digital currency is Bitcoin, which fails to fully perform all three of these functions together. It is a store of value, but it does not function well as a unit of account and as a medium of exchange. It does however, fulfill an additional requirement of a cryptocurrency in that it is decentralized and trustless. Bitcoin effectively removes the need for one to trust a third party, and removes the counterparty risk through its decentralized consensus design.

In an embodiment, network 200 is used to implement a blockchain-based cryptocurrency (referred to herein as “Stable Coin”) that is fully decentralized and uses a permissionless public chain, and that also fulfills the three main functions of a currency. The Stable Coin currency uses the cost of production and the miners' arbitraging behavior in a proof-of-work system as the key feedback to establish a long-term equilibrium price for the market. Such equilibrium price essentially anchors the unit of accounting in the Stable Coin system to the global competition of electricity prices, which is more stable in real value than any fiat currencies in the world based on the historical data. This currency eliminates the burden on decentralized application (dApp) developers to dynamically price their goods or services based on off-chain exchange prices, which is not only difficult to implement properly, but also extremely confusing to customers. The protocol of Stable Coin lays the foundation for a stable cryptocurrency reference that paves the way for more sophisticated financial services and instruments like lending, insurance, options and derivatives to be built correctly.

Stable Coin is a stable cryptographic virtual currency that functions in all three capacities of a currency, particularly as a unit of account and medium of exchange. It creates a stable reference of value for the cryptocurrency world by linking to values from the physical world, and is built on the same decentralized, permissionless, and autonomous principals as Bitcoin and Ethereum. Advantageously, the Stable Coin currency supply is designed to automatically expand or contracts with changes to the underlying economy such as the number of dApps and fluctuations in their usage. The value of a Stable Coin in effect is neither deflationary nor inflationary in the long run.

The Stable Coin protocol utilizes one or more algorithms that fulfill certain requirements to adjust the supply based on market demand. First, a crypto currency system in which each coin's cost of production (mainly driven by the cost of electricity) is stable. Second, using the total network hash rate as proxy for total electricity spending by the miners. The profit chasing behavior of the miners will cause deploying or removing computation power to the system. Third, scaling the crypto currency production (for example block reward in a blockchain-based system) based on the total energy consumption of the miners. Fourth, maintaining a relatively statistically stable cost of production in terms of energy for each coin. This is done by indirectly deducing the total network hash rate by the difficulty of mining and recent block periods, and adjusting the block reward based on mining difficulty; and by adjusting the rate by the energy efficiency of different mining hardware, and using the efficiency frontier of mining hardware as a benchmark. This approach can be expanded by useful computations as well, as long as the energy required for the computation is measurable. Fifth, providing a built-in mining tax to the miners or inflating the coins created. Certain tokens can be auctioned on a daily basis and a percentage of the proceeds will go to a reserve and distributed to validators as block rewards. Sixth, providing a cryptocurrency system with one PoW-based sub-system with significant and stable cost of production for each token based on the amount of computation or energy required for the computation. Use such a token as anchor value for issuing new tokens on different cryptocurrency subsystems with the same or different consensus mechanisms (for example PoS or delegated proof of stake). The PoW-based sub system provides disciplined monetary policy to create standard unit of account for values in entire system and the ultimate value settlement records. Other sub-systems could be optimized for scalability, latency, flexibility, lower cost, and so on, as they do not have to perform the heavy processing required for PoW calculations.

With respect to the three functions of a currency, Stable Coin has an uncapped supply, is neither deflationary nor inflationary, and its relatively stable price design helps it satisfy the unit of account and, relatedly, the store of value functions. Its infrastructure supporting multiple blockchains enables it to be a medium of exchange with high throughput and efficient transaction times.

In a PoW system like Bitcoin, computing power is consumed through the process of mining, in which the cost for the computing power is paid in fiat currencies (e.g., U.S. Dollar) and the revenue is received in cryptocurrencies. The cost of mining can be divided into a fixed cost in semiconductors and a variable cost in energy consumption. The semiconductor factor also impacts the energy efficiency in mining measured as GigaHash/Second/Watt. On the revenue side, the incentive for mining is the block reward and other related transaction fees. Each miner, either independently or collaboratively as a mining pool (e.g., 205 in FIG. 2), races to be the first to solve a cryptographic puzzle for a specific block. The miner that first solves the puzzle receives the block reward and puts their block on the blockchain. The incentive to obtain the reward while racing against other miners to solve the puzzle makes mining a highly competitive activity. The competitive nature of mining drives the activity towards the equilibrium state. Based on microeconomics theory, the equilibrium state in this competitive mining scenario should be: MR=MC, where the marginal revenue (“MR”) of production should be equal to its marginal cost (“MC”), which should also be equal to the selling price (also known as the competitive price). Competition will drive miners, as self-interested actors, to the equilibrium state, resulting in the competitive price, which is otherwise the market price. The cost of electricity constitutes the bulk of the miners' marginal cost.

It has been shown that it is possible to calculate Bitcoin's competitive price, which tracks closely to its actual market price, by calculating the marginal costs of mining. The protocol of Stable Coin is designed similarly, as a PoW-based cryptocurrency, except that the marginal cost of mining should be stable that will tend towards a stable competitive price. As the energy efficiency improves with the release of better mining hardware, corresponding adjustments will be made to account for those improvements. Moreover, for a relatively smaller time window, the marginal cost could be proxied by the hash rate. For a longer period of time, it requires periodical adjustment by the mining hardware efficiency. If the production of cryptocurrency scales with the hash rate of the network, the competitive price for the cryptocurrency should be relatively stable. Miners are profit driven, so if they observe a rise in the price of Stable Coin, they will deploy more computing power to mine Stable Coin. If the price of Stable Coin drops, their margins will shrink and miners may move their computing power to other cryptocurrencies. In both scenarios, whether miners add or stop adding Stable Coin coins to the market and thereby cause the price to decrease or increase respectively, the invisible hand of the market will keep the Stable Coin price stable. This is the arbitrage behavior of miners, and fundamentally, such a scheme anchors the cost of production for each Stable Coin to the global competitive electricity price.

Stable Coin is created to be a real currency with a long-term equilibrium value. However short-term volatilities are expected especially when the Stable Coin economy is still young. Additional monetary policies are implemented to absorb such volatilities. Such monetary policies will be continuously tuned and evolved with a protocol. Proper governance mechanics are implemented through a separately issued governance token. For major changes to the monetary policy, Stable Coin production and new features to be added to the main chain may require voting to be initiated by the governance tokens (and subject always to prevailing regulatory requirements). The governance token (“MTRG”) is responsible for maintaining the blockchain ledger as well. Thus, the governance token is a key part of a hybrid consensus protocol which makes Stable Coin many multiple times faster than traditional proof of work based blockchains. It also does not suffer the typical problems in proof of stake blockchains like nothing at stake, long range attacks, and weak subjectivity.

### Hybrid Consensus Process

For a cryptocurrency based on PoW consensus, the network hash rates can be very unstable. In certain cases, mining pools have tried to game other PoW cryptocurrencies by causing the network hash rates to fluctuate significantly. For example, Bitcoin Cash, Fedoracoin and other proof of work based cryptocurrencies suffered such attacks resulting sometimes in the networks waiting hours or days for the next block to be solved.

Embodiments of FIG. 2 provide a hybrid consensus method 218 for blockchains. As stated previously, in a typical blockchain system, the ledgers are maintained by the miners (proof of work system PoW) or validators (proof of stake system PoS). Miners or validators maintain the security and keep the ledger of the system, in return the system rewards them with newly minted coins and transaction fees. In such system the rights for minting coins and bookkeeping are the same. This leads to certain issues described in the Background section above.

Using the hybrid consensus method 218 in system 200, token mining and bookkeeping functions are separated from one another. The PoW based approach is used for mining and selecting the committee/block proposers in a PoS system to maintain the diversification of the token holders. The PoS system maintains generates the blocks and rewards for the miners and maintains the ledger and accounting for the system. The PoS system could be based on the same token or a different token with certain governance or ownership links to the token that was mined.

In the Stable Coin cryptocurrency system, there are miners who are in charge of creating currencies and validators who are in charge of maintaining the public ledger and bookkeeping. The PoW miners do not directly process transactions, but instead create the necessary randomness and the notion of time in the PoS system to improve decentralization and resilience to attacks. They can also do this by creating their own mining reward transactions in the PoW blocks. The notion of time is provided by the physical time it takes to solve each cryptographic puzzle and as recorded by the timestamp. Because a finite amount of time is required to solve a puzzle (albeit possibly very short), blocks cannot have the same timestamp. Likewise, the identity of each solving miner is random from one puzzle to the next. The collaboration between the PoW miners and PoS validators adds the necessary randomness and aspect of time to the PoS currency token generators to make the financial system more stable, secure and scalable.

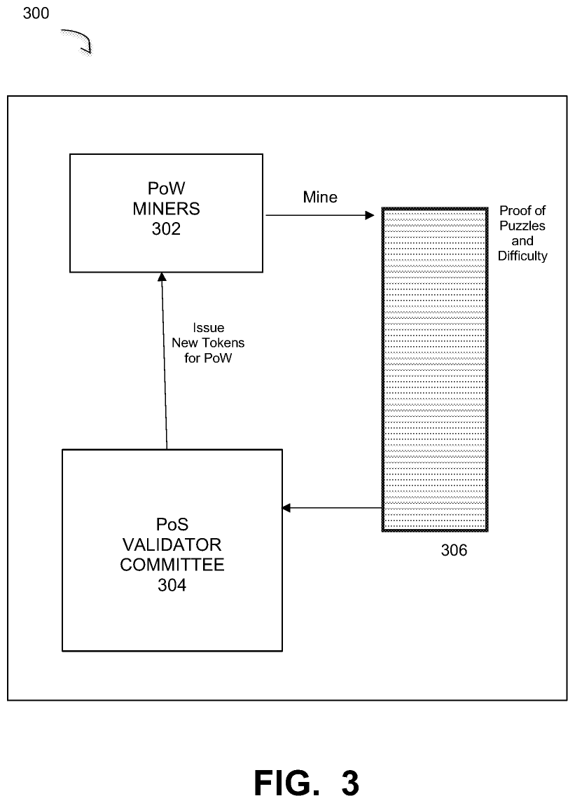

FIG. 3 illustrates an overall architecture of a hybrid consensus system for cybercurrency blockchains, such as Stable Coin, under some embodiments. As shown in diagram 300, new currency tokens are issued by a PoS validator committee 304. The committee is selected by a PoW process performed by miners 302. The miners 302 using PoW methods such as inverse hashing, mine solve puzzles and broadcast results for comparison against blockchain ledger 306. Ledger 306 contains entries that comprise proof of the cryptographic puzzles and difficulty. The crypto puzzle defined in the PoW protocol is used to generate a number (n) new tokens based on the difficulty of the puzzle. Thus, solving the puzzle leads to these new tokens being issued by the PoS validator committee 304 to the miner. Validation of the new blocks is performed only by a validation committee 304 made up of consensus nodes (executing process 218). The consensus nodes (members) of the validation committee are selected using the PoW mining method. In the committee 304, one random validator will be a proposer (as may be generated by a pseudo random process) to propose a block to be added, and a majority (⅔) of the other committee members must approve the proposed block. This selected block is then recorded on the blockchain and a token reward is sent to the miner 302.

In an embodiment, the puzzle and tickets shown in FIG. 3 are just regular blocks in PoW blockchain 306 except there are no transactions filled in the blocks (the solution to the puzzle and difficulty levels of the puzzle are standard entries in the PoW blockchain). The PoW miners will validate these blocks as well to make sure they are valid, including whether the solution of the puzzle and the difficulty of the puzzle are correct. With respect to difficulty, in general, the validators decide how many reward tokens to issue each PoW miner that has discovered a block. Difficulty is based on number of miners and the computing power in the network competing for the block. In an embodiment, system 300 changes the block award based on the difficulty, and each discovered block may have a different award.

In some embodiments, there may be either one or two tokens that are used in system 300. In the case of two tokens, there may be an economic token used by the PoS validators as their stake. This token extracts or measures the economic value for handling transactions within the blocks. The other type of token is a currency or reward token, which is the token awarded to the miners for discovery of winning blocks. The economic and currency tokens are economically connected to align the interests of the different token holders. This can be done through the mechanism of transaction fees, auctions to get into validation committees, and other types of incentives. In this case a portion of the currency paid becomes part of the reward to the miners, and the PoS validators collect transaction fees for handling transactions and for block rewards and the transaction fees can be included in the currency (reward) token. This economic linking may also be provided through some sort of exchange system in which one gives up some amount of currency token in exchange for economic tokens using an agreed upon exchange rate, or an auction system. In the case of an auction based incentive system, embodiments include a burn process in which at least some proceeds of an auction may be destroyed to create continuous demand for the currency tokens.

In an alternative embodiment, the same token may be used for both functions. That is, either an economic token or currency token may be used as the only token in the system.

FIG. 3 illustrates one example of the interplay between the PoW and PoS actors and many other variations are also be possible. Additionally, the PoS validators store a record of the PoW transactions and observe all the blocks to make sure that all the transactions are valid. Such validators may be in a full node 203. In this case, the full node validators will observe and not write blocks. In general, a full node 203 is a node that stores all the blockchain information. It may not stake any tokens and may not be the validator pool at all. It basically just reads but does not necessarily write blocks to the blockchain.

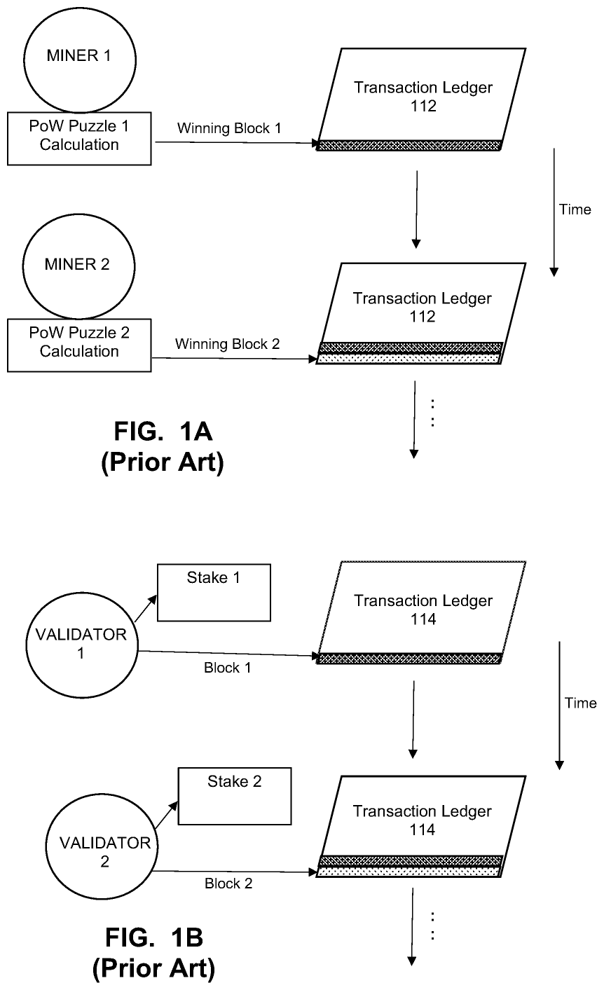

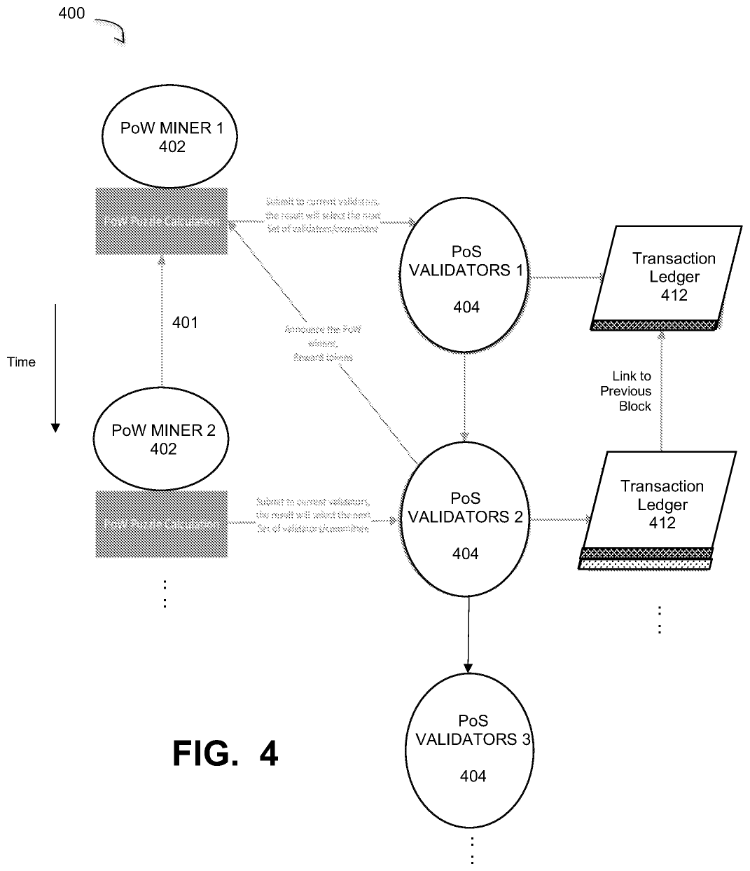

FIG. 4 illustrates the use of PoW processes in conjunction with PoS block creation and validation in a hybrid consensus method for a blockchain system, under some embodiments. Diagram 400 illustrates the transactions between the PoW miners, PoS verifiers and the blockchain transaction ledger and expands on the present known systems shown in FIGS. 1A and 1B. Under those prior art systems, the miners or validators both interacted directly with the blockchain for both writing and validating blocks. Unlike those systems, the system of FIG. 4 isolates or separates the PoW mining function from the validation function.

As shown in FIG. 4, a miner (Miner 1) 402 performing a mining process generates new blocks based using a PoW puzzle calculation. The new block contains a random number, such as a nonce or other random number, which is used to select a committee of validators 404. The current committee of validators includes a block proposer that proposes a block to be written to the transaction ledger. If the proposed block is validated by a sufficient number of the other committee members, it is written to the ledger. After the first block is written, a new committee is formed, as shown by the transition 409 from Validators 1 to Validators 2. The composition of Validators 2 is determined by the PoW puzzle calculation performed by Miner 1 and the random number submitted by Miner 2 to Validators 1. For this new Validators 2 committee, a new block proposer proposes a block to be written and if this block is validated by the other committee members, it is written to the transaction ledger 412. In the meantime, PoW Miner 2 solves a puzzle calculation and submits the resulting block and random number to the Validators 2 committee to determine the composition of the next Validation committee (e.g., Validators 3), and so on. In this manner new validator committee from which a block proposer will be selected are formed using random numbers provided through the PoW miner processes. The puzzles required to be solved by the miners through their calculations take certain amounts of time and provide the necessary time aspect to fix the added blocks to the ledger in a way that cannot be faked or forged.

It should be noted that a committee once formed may generate a number of blocks to be written to the blockchain. A proposer within the committee is selected and validated blocks are written to the blockchain. The proposers within the committee may rotate, such as in a round-robin fashion or on the basis of their probability of being selected based on the amount of their stake. The same committee will continue to generate blocks until the validation committee is reformed. Such reformation may be triggered by the PoW chain or by a fault or problem situation seen in the PoS chain. In an embodiment, a threshold value is attached to the PoW chain with respect to the number of discovered PoW blocks. When the PoW chain becomes long enough (at or over the threshold value), a new PoS validation committee will be formed. In certain cases if it appears to have been too long between formation of validation committees, a new committee may be formed. For example, if a threshold for the PoW chain is 30 blocks, and the PoS chain is well over this number of added blocks, a new validation committed may be formed. The PoW chain, as well as the entire candidate pool of PoS stakeholders observes the PoS chain to monitor the length of time between validation committees.

With respect to the PoW miners, current proof of work methods may be based on cryptographic puzzle solving, as described with respect to FIG. 1A. However there could be other implementation variants as well, as long as the resource profile of the work or computation can be understood and cannot be faked. It can be used as a link between the physical world and the virtual world. For example, a TEE (Trusted Execution Environment) environment (supported in many modern processors) can be used in which one can ensure that software code running in a special hardware enclave unmodified. In this method, the system could verify the processor type and the energy requirement for a certain computation. It is possible to build proof of useful work like running the smart contract of the system and use such computation as unit of account for the system. Other similar PoW methods may be used, as alternatives to the usual crypto puzzle solving method.

In system 400, the PoW mining process is utilized with a PoS based validator selector method. As shown in FIG. 4, the validators 404 may be organized as a restricted set of nodes forming a committee within the entire network. For each block processing cycle a current set of committee members (Validators 1) is used to determine the composition of the next set of committee members (Validators 2). So the block generated by Miner 1 is sent to committee 1. For the next block, the miner will almost certainly change as part of the random mining process and the validator committee will also change. Actual methods for this selection process selected for the validation committee are described greater detail below.

As shown for the example of FIG. 4, the block sent by Miner 1 is used to select the consensus nodes that comprise the next committee of validators (Validators 2). Miner 2 generates a block that is submitted to the Validators 2 committee, which writes the validated block to the transaction ledger 412. This set of validators also announces the PoW winner for the previously written block and rewards tokens to that miner (in this case Miner 1). This process then repeats over time to add new blocks to the transaction ledger 412. As can be seen in FIG. 4, Miner 2 mines for blocks under a PoW process while their validated blocks are validated and written to the blockchain by respective validator committees selected under a PoS method. This effectively separates the block generation and writing functions for execution by two different sets of actors using both PoW and PoS consensus methods. Link 401 indicates the existence of the blockchain grown by the miners 402.

Depending on system configuration, such as whether fast throughput and instant finality are desired, the PoS subsystem for validator selection could be based on a broad range of stakeholders or a smaller committee elected from stakeholders with fast Internet connection, computation and storage. In an embodiment, a committee is comprised of a set percentage of nodes (e.g., 10%) within the entire set of nodes or stakeholders.

For the embodiment of FIG. 4, the results from the first set of PoW puzzle solutions is used as a random number to select the next committee or subset of validators. To avoid potential forking scenarios, only one winner who received greater than or equal to ⅔ of the approval from the committee will be selected. The miners who work on a PoW basis will receive the block rewards based on the actual computation work they performed. The tokens used by the stakeholders for staking could be the same token mined by the PoW workers or a different staking token. In addition, a small percentage of the block reward maybe given to the PoS validators for their work. The PoS validators could also be supported by transaction fees or inflation of PoW coins, proceeds from auctions and so on.

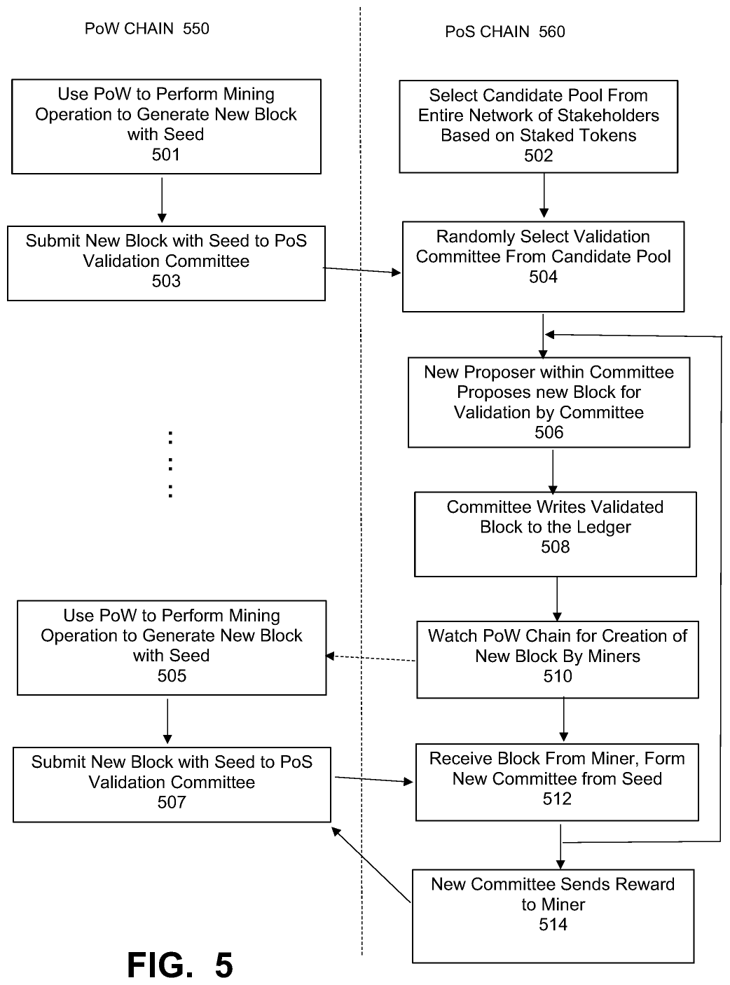

FIG. 5 is a flowchart illustrating an overall method for hybrid PoW/PoS consensus in a blockchain system, under some embodiments. FIG. 5 illustrates two major strands or chains, the PoW chain 550 for the miners and the PoS chain 560 for the validators. In an embodiment, two different peer-to-peer networks are used the PoW chain and the PoS chain.

The method of FIG. 5 begins with the formation of the candidate pool of validators 502. This candidate pool is selected on the basis of an amount of tokens staked by each stakeholder node, as may be done per usual PoS procedures. From this candidate pool, which may be relatively large (e.g., thousands of nodes), a validation committee is randomly selected, 504. Each of these validation committee nodes represents a stakeholder that would can propose blocks for recording and participate in block validation process. The candidate pool selected in 504 may be a defined size subset (e.g., 10% of the nodes) of the candidate pool. Thus, out of the entire candidate pool, only the smaller number of validation committee stakeholders will actually be eligible to write and validate blocks. The random selection of the validation committee is done using a seed produced by a PoW miner. Each generated PoW block contains a random number (e.g., a nonce) which is used as a seed value by the PoS chain to randomly select a validation committee.

In the PoW chain 550, the miners generate blocks using PoW puzzle solving to generate new blocks for broadcast to the PoS chain 560, step 501. A PoW miner who successfully solves the present crypto puzzle submits the new block with the seed to the PoS validator network 560, as shown in step 503. This seed provides adds a necessary degree of randomness to the PoS chain to overcome some of the problems described above with respect to present PoS systems. Likewise, the puzzle solving of the miner provides a necessary absolute time aspect to the PoS chain.

In an embodiment, the PoW miners all compete to solve the puzzles and generate the winning block. Each miner broadcasts their chain, and winning blocks are built on by the other miners. Chains that have the most blocks thus contain the winning blocks. This activity is observed by the PoS chain, which watches to see when a block is created by the PoW chain. A threshold thus is defined for the minimum length of chain for which the PoS side will select the winning PoW block and the corresponding miner. For example, if the threshold is set at 30, the miner that finds the 31st block will be selected to be the winning miner and their block will be used to provide the seed value to the PoS side. Thus, if N is the threshold, the miner who finds the N+1 block will submit its block to the PoS side, and the random number in the winning block is used as the seed for new validation committee selection, where N can be any practical number.

With respect to the validation committee selected from the candidate pool, within this committee, the members take turn to be the block proposer. The current proposer proposes a block to be written and other committee members that validate the node in accordance with usual PoS consensus methods, 506. If a proposed block is validated by a sufficient number of committee members, it is written to the blockchain ledger, 508. One committee may produce several blocks. In step 506, the proposer within the committee also rotates. As stated above, this rotation can be done in a round-robin fashion, a stake-based fashion, or any other appropriate method, such as random selection, and so on.

The PoS chain nodes watch the PoW chain for generation of newly mined blocks, 510, and use blocks from the longest chain based on the predefined threshold described above. New blocks with seeds are generated and submitted to the PoS chain from the PoW miners as shown in steps 505 and 507. The new block with the random number seed is thus submitted to a current validation committee by the winning PoW miner, 505. The current committee receives the block from the winning miner and forms a new committee from the seed, 512. In step 512, and for the new committee, when the observed PoW blocks are longer than a predefined threshold (e.g., 30 blocks), the proposed block from the PoS proposer is validated. If not, the process proceeds again from step 506 and the proposal of a new block.

The new committee performs the PoS block proposal and validation process to write a new block and sends a reward to the miner. This process then repeats for subsequent blocks through the act of forming new PoS validation committees using the random number and time-based puzzle solution of the PoW miners.

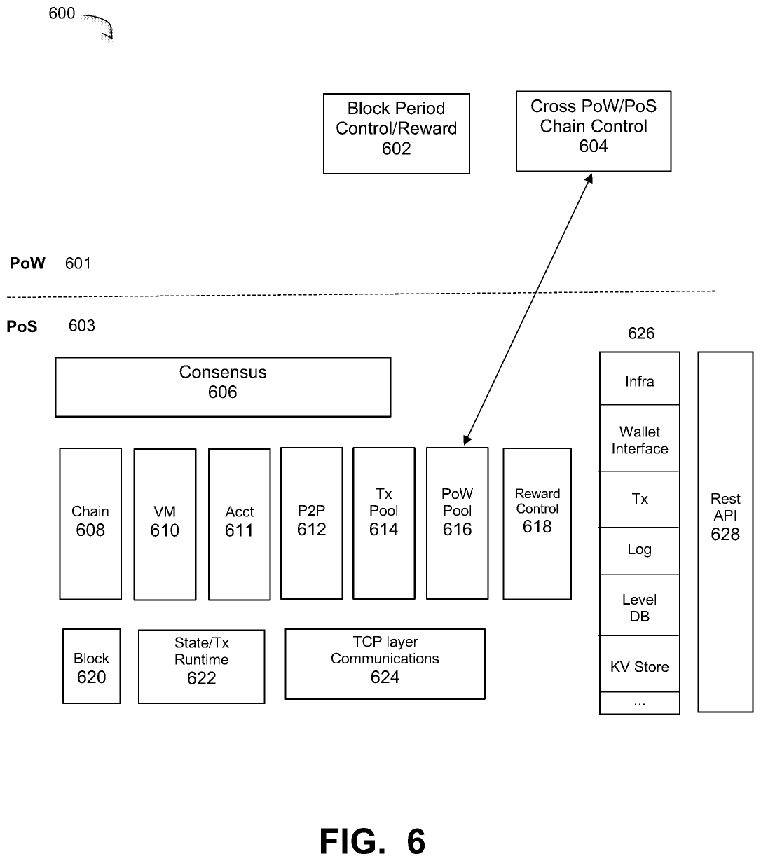

As described with respect to FIG. 2, embodiments of the hybrid consensus method are executed in a distributed (peer to peer, P2P) network having a number of different nodes, each implemented as a computer or other computing or processor-based device executing software programs and/or having configured or programmed hardware. In a software-implemented embodiment, each node executes certain software modules. FIG. 6 illustrates the functional components and software modules in a processor-based system for a hybrid consensus method, under some embodiments. For the embodiment of FIG. 6, diagram 600 illustrates at least some of the components executed by consensus process 218 running on the corresponding nodes. The modules are divided into modules PoS side modules run on the consensus nodes 218, and the PoW side 601 run on the mining nodes 204 or farm 205.

The PoS side 603 illustrates a system level representation of the functional components of the consensus process 218. Consensus module 606 represent software modules that execute the consensus engine to maintain the chain structure 608, virtual machines (VMs) 610, user accounts 611, the P2P network for the PoS distributed network, the transmission (Tx) pool, and the PoW pool.

As stated previously, the overall system 200 may have two separate P2P networks, one for the PoW side 601 and one for the PoS side. In this case, the PoW side communicates within its own P2P network and PoS side communicates within its own P2P network. The P2P module 612 controls the network on the PoS side and the a cross PoW/PoS chain control module 604 on the PoW side communicates with the PoS side through the PoW pool 616.

As shown in FIG. 4, a reward is provided by the PoS validator committee to a winning miner based on solving a corresponding puzzle. A reward control module 618 on the PoS side dictates how to calculate the reward. Unlike present implementations of Bitcoin that have a fixed reward changed infrequently (e.g., every 4 years), embodiments of the hybrid consensus system change the reward on a block-by-block (or other frequent periodic basis) based on the difficulty of solving the puzzle. The system is configured to change the reward based on the hash rate, as indicated by a change in the difficulty of solving a puzzle changes. Thus, a change in difficulty of 10% equals 10% more reward. This is just a simple example, and other ratios of increases are also possible. The PoW side 601 includes a reward module 602 to process rewards sent by the PoS side. It also includes a block period control module to control the block period for the PoW mining process.

Further with respect to FIG. 6, block control module 620 creates new block from the PoS side for a selected block proposer within a validation committee. State/Tx runtime module 622 is a state machine that maintains the current state of each account (e.g. balance, storage space, etc.), and the TCP layer communications module 624 is a higher level network communication layer, above the P2P layer 612. In an embodiment, the PoS layer communicates through a Rest API (Application Programming Interface) 628, and elements 626 are the individual API components for this API including infrastructure, wallet interface, transmission, log, and so on.

The components and configuration of software modules shown in FIG. 6 are provided for example, and embodiments are not so limited. Any other appropriate software, hardware, or firmware modules and components may be provided based on system configuration.

In an embodiment, the PoS nodes 218 may also run the PoW processes 601 to monitor what is happening on the PoW side. In this case, the PoS chain stores all PoW and PoS transactions, while the PoW miners 204/205 store only the PoW chain itself. In a full node embodiment, the full node 203 contains the full node for PoS and PoW.

### Consensus Protocol

In an embodiment, the consensus protocol illustrated in FIG. 4, such as for the Stable Coin cryptocurrency is a variant of fast Byzantine agreement, where a Byzantine agreement is a protocol in distributed computing to bring nodes to an agreement despite a fraction of bad nodes behaving to corrupt the result. The consensus mechanism itself can be paired with any method of Sybil resistance (proof of work or proof of stake) to create an open participation model. In the Stable Coin system, proof of stake is chosen for Sybil resistance for the purpose of providing an additional layer of security as well as checks and balancing in the economic incentive design. It allows users to agree on a log of transactions and achieve consistency and liveness. With respect to consistency, if a transaction A is confirmed by the protocol, any future transactions confirmed by the protocol will appear in the log that already contains A. This holds even for isolated users that are disconnected from the network (for example, by Eclipse attack). With respect to liveness, the consensus protocol makes progress under the assumption that more than ⅔ majority of the participating validators (elected through a PoS delegation process) are honest and the network is in “strong synchrony” (meaning that most honest users can send and receive messages from other honest users within a known time bound). It will maintain security when the network is in “weak synchrony” (temporarily overtaken by adversary) until the network is back to synchronous mode.

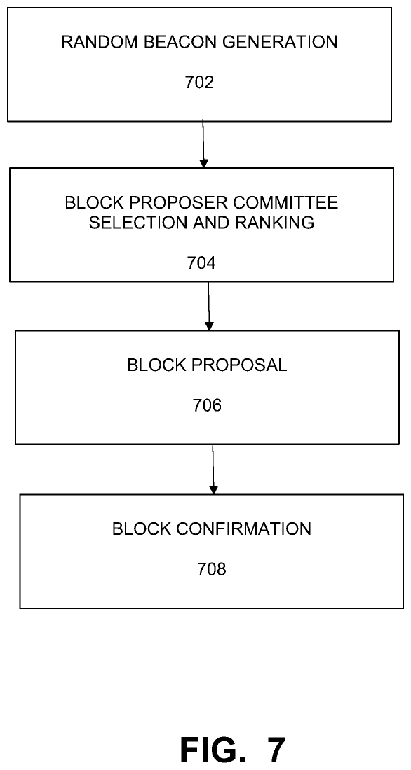

FIG. 7 illustrates a method of the consensus protocol as a variant of a Byzantine Agreement, under some embodiments. FIG. 7 illustrates certain steps executed in the protocol. The first step 702 is random beacon generation. Decentralized randomness is the core of a truly decentralized blockchain system. Bitcoin implicitly creates the randomness through the global race involving miners searching for the hash solution to the puzzle. Proof of stake systems lack such schemes and need to explicitly create one. For example, Dfinity consensus protocol (Hanke 2018) leverages the BLS signature schemes and Algorand (Gilad 2017) relies on verifiable random functions (VRFs) for generating random numbers, which are used for creating the committees in the later steps.

In an embodiment, the PoW miners in the Stable Coin system function as the random number generator. They work on a side chain with a purely proof of work basis called the Committee Election Relay (CER). The CER regularly splits and merges with the main chain to trigger the committee re-election and ensures the liveness of the main chain (the period between each split and merge is called an Epoch). The transactions on CER includes the block rewards for each miner (which will be confirmed on the PoS main chain) and the Merkle root of all the transactions on the main chain during the split period. There could potentially be multiple CER forks running among the miners, only the miners on the longest CER confirmed by the next main chain block receive their corresponding block rewards. The block periods on the main chain and CER are different. Initially the block period on the main chain is to be set as 10 seconds, while the CER chain block period set as two minutes. Due to the nature of PoW mining, the block periods on CER follow an exponential distribution. CER and the main chain should have a merge whenever there are more than 30 blocks on CER to trigger a committee re-election and data synchronization with the main chain. The design choice of 30 blocks is mainly to reduce of the volatility of the committee re-election period and wider distribution of block rewards, and other lengths are also possible.

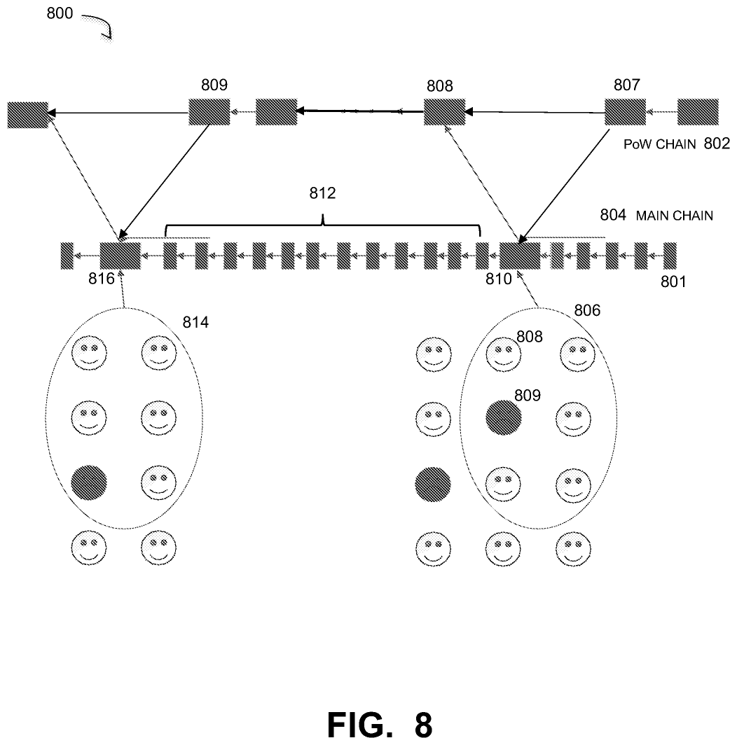

FIG. 8 graphically illustrates an interaction among the PoS and PoW chains and validation committee formation in an hybrid consensus system, under some embodiments. Diagram 800 of FIG. 8 illustrates time evolving process for the PoW chain 802 and the separate PoS chain 804. The PoW chain comprises the generation of a series of blocks 808 generated by the miners in the system. The frequency of the block generation in expressed in terms of a block period of the PoW chain.

As shown in FIG. 8, the PoS chain 804 consists of a number of blocks that are proposed and validated by a number of nodes formed into a committee 806. With respect to a validation committee 806, nodes 808 represent reliable nodes, while some nodes (darkened) 809 are assumed bad, such malicious, offline, or otherwise unreliable nodes. Under standard Byzantine network assumptions, it is assumed that less than ⅓ of nodes are a bad and it is expected that the composition of each committee 806 will have at least ⅔ good nodes and not more than ⅓ bad nodes, though actual numbers may vary from committee to committee. This leads to the assumption that no stakeholder will control more than ⅓ of the stakes, though certain mechanisms such as slashing can be used to reduce conflicts.

As shown in FIG. 8, the PoS chain 804 comprises a number of small blocks 801 and bigger blocks 810, which are referred to as “key” blocks where the validation committee reelection process occurs. In between these key blocks (i.e., during the period of regular blocks 812), the committee members are the same and blocks written to the blockchain are all generated by this committee. Within the committee 806, a block is proposed by a block proposer and validated by the rest of the committee. The block proposer role may be rotated among the committee members. Each of the blocks 812 maybe proposed by different proposers and then validated and signed by more than ⅔ of the committee members. This can be considered an implementation of a Byzantine fault tolerant (BFT) consensus that allows the system to continue to operate even if some of the nodes fail or act maliciously.

In an embodiment, the reformation of committees, such as from committee 806 to committee 814 is triggered by the PoW chain 802. As described previously, the winning PoW miner provides a block that contains a random number that is used to determine the formation of the new committee. Thus, as shown in FIG. 8, PoW block 807 determined committee 806 and block 809 determined committee 814. The new committee may be selected when the PoW blockchain reaches a certain length above a defined threshold, or it may be triggered if the period of time 812 is deemed to be too long by the PoS chain, the PoW chain or the entire candidate pool of stakeholders.

An epoch is defined to be a period of time within which the committee is the same, and thus may be the time from block 810 to block 816 and encompassing blocks 812 in FIG. 8. In an embodiment the CER process jump starts a new epoch, such as 810 in which it re-elects committee 806 members and forms new ranks. Between epochs, the committee is reformed so that committee 806 in epoch 810 is changed to committee 814 in epoch 816. Thus, new committee 814 is elected at the beginning of a new epoch. Although some members may be the same, typically a new committee may have all new members. When the committee is big, the probability for more than ⅓ bad nodes becomes extremely low. The committee members propose new blocks based on ranks. As shown in the example embodiment, the epoch period for the PoS chain can be different to the block period in the PoW chain.

With reference back to FIG. 7, the second step, 704 is block proposer committee selection and ranking. The block proposer committee is elected from the proof of stake delegates pool. In this case, the individual delegates could be labelled 1, 2, . . . ∈U, where N is the size the of the committee, and N<U. When N is large enough (e.g., a few hundred), the probability for more than ⅔ of the delegates to be honest becomes extremely high. The random beacon β generated from the first step (based on the longest CER as confirmed by the existing committee) could be used for re-electing part or the entire committee from all the delegates. In the initial phase, when the Stable Coin network is still relatively small, the committee will likely to be all the qualified delegates of the stake holders. At this stage, the main application for β will be ranking the order of committee for block proposals. The beacon β functions as the seed for a cryptographic sort, which ranks committee members from 1 to N. The highest ranked committee member will announce the start of a new Epoch. Delegates can be elected in and out of the committee at the starting of the Epoch.

The third step, 706, is block proposal, in which each committee member proposes a new block in rounds based on their ranking order. A valid block proposal B in round r should be: H(Bᵣ)=confirmed(Bᵣ₋₁), where confirmed(Bᵣ₋₁) is the last confirmed block data in Bᵣ is valid. Assuming Bᵣ₋₁ is confirmed, if the committee member in charge of round r fails to propose a or obtain confirmation of a block within the BlockTimeOut period, the committee member in charge of r+1 will start proposing based on confirmed (Bᵣ₋₁).

The fourth step is block confirmation, 708. As soon as a committee member receives a block proposal. It starts signing the first proposal from the block proposer for the round and broadcasting the signature. It always listens to signature messages from its peers. As soon as the accumulated signature for Bᵣ reaches less than ⅔ quorum, Br is confirmed with a confirmation signature confirmed (Bᵣ). Any messages for round r and earlier will be refused once confirmed (Bᵣ).

Such a consensus algorithm does not require the network to be in strong synchrony all the time and will survive sovereign grade network attack and partitions. For example, if more than ⅓ of the committee members goes offline due to network partition, the block production will halt. However, the proof of work miners will continue to work in their respective network islands. As soon as the network connection restores, the longest proof of work chain will trigger a committee reshuffle and a new epoch. It is believed that such behavior is safer for regular consumers than the random behavior in the traditional proof of work system like Bitcoin, in which although the transactions seem to be still moving forward and confirmed based on the network islands surrounding a user, they could be completely erased by a longer chain after the network partitions merge back. The Byzantine agreement style fast consensus scheme ensures short latency (e.g., under 5 seconds block time), high throughput (around 1000 transactions per second at launch and scales to billions of transactions per second through sharding, side chain and multi-layer consensus) and instant finality (it is impossible to fork and reverse transactions by proposing a longer blockchain).

A major drawback of current consensus protocols based on PoW is energy consumption and waste. Unlike these schemes, the Stable Coin cryptocurrency network hash rate only responds the demand for additional currency in the system rather than the price of the currency. In other words, the network energy consumption scales with the increment of market cap rather than the total market cap of Stable Coin.

The PoW process typically provides the following benefits to a PoS consensus scheme: (1) Sybil resilience; (2) randomness; (3) notion of time; and. (4) permission-less means to access currency. The hybrid consensus of the Stable Coin cryptocurrency described herein leverages on proof of stake for Sybil resilience and still relies on proof of work for the rest. Performance and instant finality wise, it is on par with the most advanced proof of stake consensus algorithm. In addition, it does not suffer from the common flaws in proof of stake systems, such as accumulation of wealth (rich become richer), nothing at stake, long range attacks, and weak subjectivity.

The overall system provides a notion of time (time stamp) and randomness which are typically lacking in traditional PoS methods. It also prevents currency creators (miners) from being responsible for the record keeping tasks on the ledger. In traditional systems, currency is created as reward for updating the ledger, but this has led to situations that create competitive power consumption scenarios.

### System Implementation

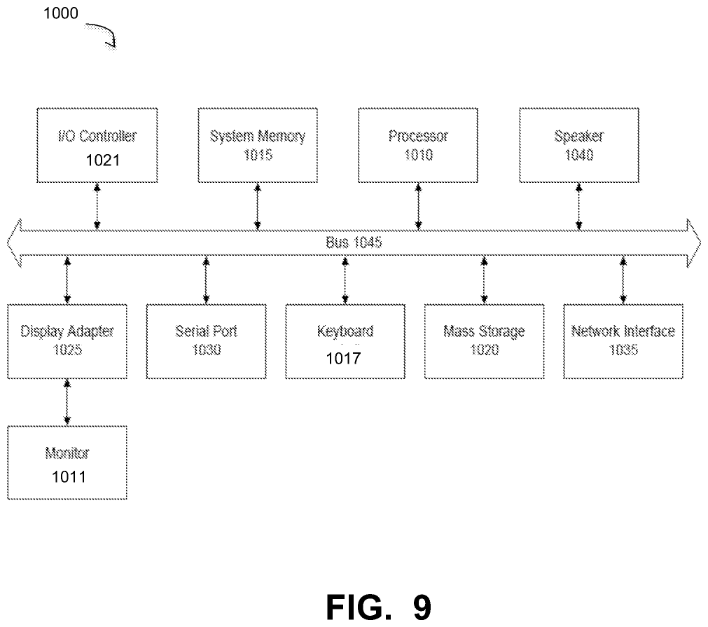

As described above, in an embodiment, system 200 includes a programmatic blockchain creation functions that may be implemented as a computer implemented software processes, or as hardware components, such as may be embodied in the nodes and resources of the system. As such, it may be an executable module executed by the one or more computers in the network, or it may be embodied as a hardware component or circuit provided in the system. The network environment of FIG. 2 may comprise any number of individual client-server networks coupled over the Internet or similar large-scale network or portion thereof. Each node in the network(s) comprises a computing device capable of executing software code to perform the processing steps described herein. FIG. 9 is a block diagram of a computer system used to execute one or more software components of the nodes of FIG. 2. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

Although certain embodiments have been described and illustrated with respect to certain example network topographies and node names and configurations, it should be understood that embodiments are not so limited, and any practical network topography is possible, and node names and configurations may be used. Likewise, certain specific programming syntax and data structures are provided herein. Such examples are intended to be for illustration only, and embodiments are not so limited. Any appropriate alternative language or programming convention may be used by those of ordinary skill in the art to achieve the functionality described.

Embodiments as described herein may be applied to mesh networks of any scale (full or partial), and may also be applied to any other physical, virtual or hybrid physical/virtual network, such as a very large-scale wide area network (WAN), metropolitan area network (MAN), or cloud-based network system. Aspects of the one or more embodiments described herein may be implemented on one or more computers executing software instructions, and the computers may be networked in a client-server arrangement or similar distributed computer network. The network provides connectivity to the various systems, components, and resources, and may be implemented using protocols such as Transmission Control Protocol (TCP) and/or Internet Protocol (IP), well known in the relevant arts.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method for managing a distributed public ledger on a peer-to-peer network comprising a plurality of nodes, comprising:
performing a proof of work (PoW) mining operation by a miner in a PoW processing timeline to generate a winning block having an associated random number;
selecting a validation committee comprising a number of proof of stake (PoS) nodes from a candidate pool of the plurality of nodes, wherein the composition of the validation committee is determined by the random number of the winning block;
proposing a block to be written to the distributed public ledger by a proposer node of the validation committee; and
writing the proposed block to the distributed public ledger if a defined majority of remaining nodes of the validation committee validate the proposed block.

2. The method of claim 1 wherein the distributed public ledger comprises a blockchain, and the mining operation comprises solving a cryptographic puzzle

3. The method of claim 2 further comprising awarding the miner a reward from the validation committee.

4. The method of claim 3 wherein the amount of the reward is proportional to the difficulty of the cryptographic puzzle.

5. The method of claim 2 further comprising using a subsequent winning block from a second miner to select a subsequent validation committee to generate a new block to be written to the blockchain.

6. The method of claim 5 wherein the validation committee and subsequent validation committee exist for a respective epoch along a PoS processing timeline, and wherein the first miner and second miner generate their respective winning blocks according to a block period on the PoW processing timeline.

7. The method of claim 1 further comprising an economic token used as a stake by the PoS nodes and which extracts an economic value for handling transactions within a block, and a currency token that is used to reward the miners, and wherein the economic token and currency token are economically connected to align the interests of different token holders.

8. The method of claim 7 wherein a single unified token is used for both the economic token and the currency token.

9. The method of claim 1 wherein the proposer node is selected through a process in which each committee member proposes a new block in rounds based on a respective ranking order.

10. A computer-implemented method for managing a blockchain, comprising:
using a Proof of Work (PoW) based consensus method for mining blocks in the blockchain representing a distributed ledger, and generating new tokens to maintain diversification of token holders; and
using a Proof of Stake (PoS) based consensus system to maintain the distributed ledger and accounting for the system.

11. The method of claim 10 wherein the tokens represent a cryptocurrency stored in the blockchain.

12. The method of claim 11 wherein the cryptocurrency uses cost of production of the new tokens and arbitraging behavior of miners of the new tokens in the PoW consensus method to establish a long-term equilibrium price of a market for the cryptocurrency.

13. The method of claim 12 wherein the cost of production is primarily composed of electrical energy consumption of computing resources for generating the new tokens.

14. The method of claim 13 wherein the miners are tasked with creating the new tokens, and validators are tasked with maintaining the blockchain public ledger and bookkeeping.

15. The method of claim 14 wherein the miners do not directly process transactions but create necessary randomness and a notion of time in the system to improve decentralization and resilience to attacks.

16. The method of claim 15 wherein the stakes for the validators are a combination of economic tokens and currency tokens.

17. A system for managing a distributed public ledger on a peer-to-peer network comprising a plurality of nodes, comprising:
a proof of work (PoW) mining node performing PoW mining operation along a PoW processing timeline to generate a winning block having an associated random number;
a node process selecting a validation committee comprising a number of proof of stake (PoS) nodes from a candidate pool of the plurality of nodes, wherein the composition of the validation committee is determined by the random number of the winning block; and
a proposer node of the validation committee proposing a block to be written to the blockchain, wherein the validation committee writes the proposed block to the blockchain if a defined majority of remaining nodes of the validation committee validate the proposed block.

18. The system of claim 17 wherein the mining operation comprises solving a cryptographic puzzle

19. The system of claim 18 further comprising the validation committee awarding the miner a reward, and wherein the amount of the reward is proportional to the difficulty of the cryptographic puzzle.

20. The system of claim 17 wherein the validation committee and subsequent validation committee exist for a respective epoch along a PoS processing timeline, and wherein the first miner and second miner generate their respective winning blocks according to a block period on the PoW processing timeline.
